(19) United States
(12) Patent Application Publication
(10) Pub. No.: US 2020/0226672 A1
(43) Pub. Date: Jul. 16, 2020

(54) LIVE VIDEO-ASSISTED SHOPPING AND PRODUCT DISCOVERY

(71) Applicant: K, Online Inc, Bellevue, WA (US)

(72) Inventors: Kevin M. DILLON, Bellevue, WA (US); Andrii KURSHYN, Bellevue, WA (US)

(21) Appl. No.: 16/744,033

(22) Filed: Jan. 15, 2020

Related U.S. Application Data
(60) Provisional application No. 62/792,769, filed on Jan. 15, 2019.

(51) Int. Cl. G06Q 30/06; H04N 7/14; G06Q 10/08; G06K 7/10

(52) U.S. Cl. CPC G06Q 30/0643; H04N 7/141; G06K 7/10386; G06Q 30/0627; G06Q 10/083

(57) ABSTRACT

Disclosed herein are systems and methods for improving electronic commerce transactions using live video chat. Product scanning, inventory database management, and/or sales transaction functionalities are integrated into live video chat communication between a customer and a retailer in many embodiments.

### CROSS-REFERENCE

This application claims the benefit of U.S. Provisional Application No. 62/792,769, filed Jan. 15, 2019, which application is incorporated herein by reference in its entirety.

### BACKGROUND

Contacting retail stores for products and advice is a cumbersome and time-consuming experience. Making a purchase after contacting the retail store and receiving advice may result in a loss of a customer as they then use the internet to search for and make their purchase.

### SUMMARY

A system and method for live video chat to assist with product discovery and shopping is disclosed. The system and method allow of integration of product information and purchasing at retail locations during a video-chat.

The advantages of the systems, devices, and methods disclosed herein are that a customer and retail employee can participate in live face to face video communication on a mobile device to assist in discovering and shopping for products. Users are able to share product data such as, inventory, technical features, style and other options, pricing data, and discuss the product live. The retail employee can push product web pages and information to the customer and can also complete a sales transaction in a single session.

An advantage of the systems and methods disclosed herein is that they allow a consumer to see what they are purchasing as well as get additional live and relevant information about the product or service prior to purchasing. A retailer or retail employee can walk the consumer around the store via live video, show them inventory and when they are interested in the product the merchant can show video of the product to the consumer.

If the consumer is interested in the product, the retailer can then scan the universal product bar code on the product and the product information will be presented to the consumer via live video chat. If the consumer would like to purchase the product, they can buy indicate they want to purchase the product and they will be directed to a checkout page within video chat that allows them to enter their credit card and delivery information (e.g., shipping information). An additional advantage is that the consumer or retailer does not need to open up additional applications. The entire shopping and purchase experience is presented and completed in the same video chat interface.

### INCORPORATION BY REFERENCE

All publications, patents, and patent applications mentioned in this specification are herein incorporated by reference to the same extent as if each individual publication, patent, or patent application was specifically and individually indicated to be incorporated by reference. U.S. Provisional Application No. 62/491,956, filed Apr. 28, 2017, and U.S. application Ser. No. 15/967,300, filed Apr. 30, 2018, are incorporated herein by reference in their entirety.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a system for live video-assisted shopping and product discovery, according to one or more embodiments herein.

FIG. 2 illustrates a method for live video-assisted shopping and product discovery, according to one or more embodiments herein.

FIG. 3 illustrates a video chat and product scanning on a user device, according to one or more embodiments herein.

FIG. 4 illustrates product information and purchase options on a user device, according to one or more embodiments herein.

FIG. 5 illustrates user purchase information input on a user device, according to one or more embodiments herein.

FIG. 6 illustrates product information on a retailer device, according to one or more embodiments herein.

FIG. 7 illustrates product information modification on a retailer device, according to one or more embodiments herein.

### DETAILED DESCRIPTION

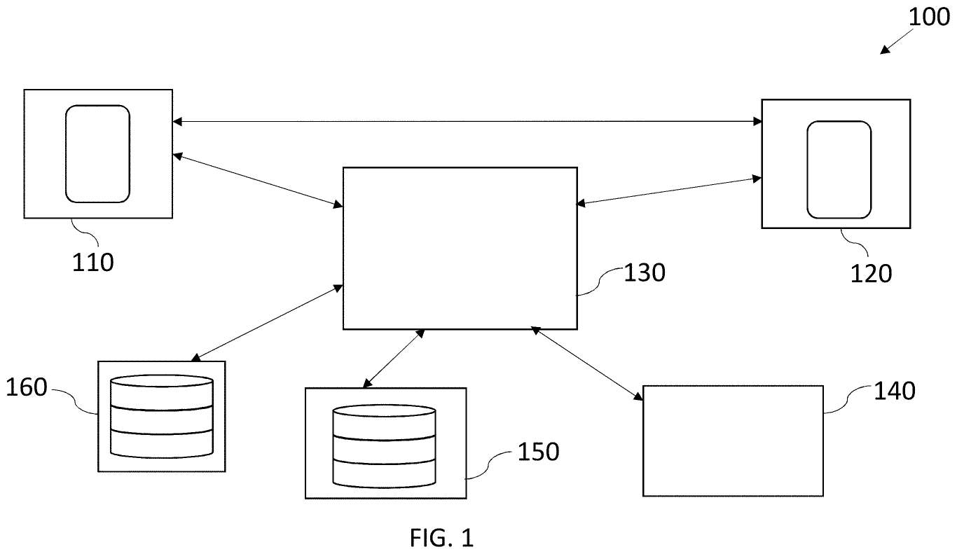

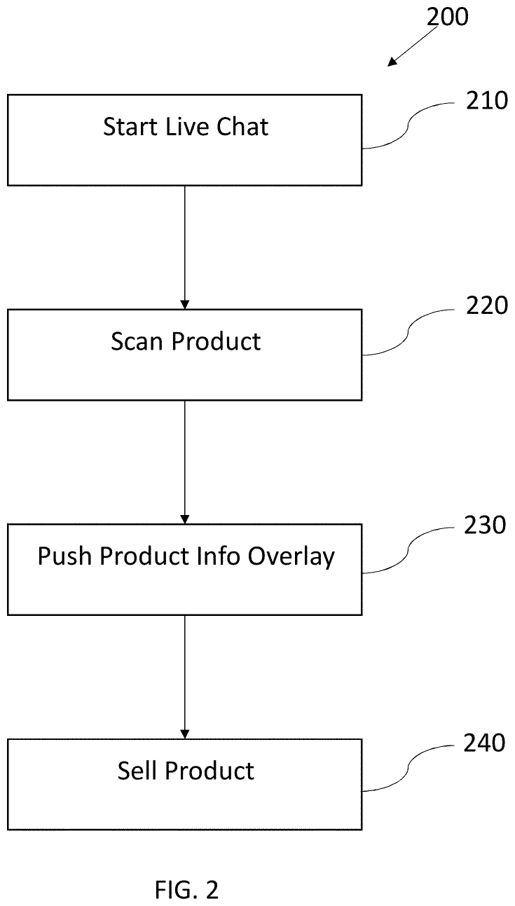

With reference to FIGS. 1 and 2, a system 100 and method 200 for live video-assisted shopping and product discovery is shown.

The systems and methods allow users, including retailer and customers to interact with one another by discovering and selecting products in order to make informed purchasing and sale decisions within a video chat interface. This is accomplished by bringing product and purchase data together and layering it on top of a video chat user interface. Product and purchase data may include data that describes the attributes and features of a product, pricing, inventory information, reviews, photos, and other information. Existing video chat systems and methods do not allow for layering of product data and purchasing on top of video chat nor do they facilitate two-way product information presentation and sales.

Presenting a customer with purchase options and/or the means to make a purchase within a live video chat call, as described herein, offers advantages for both the customer and the retailer. For example, customers are able to see the inventory that is actually present in the retailer's store using the methods and systems, which can alleviate the need to travel to a store to peruse and then purchase stocked items in person or the need to rely on a retailer's verbal description of stocked inventory. This is especially advantageous in cases when a retail item is condition-sensitive (e.g., second-hand items, collectible items, precision items, or groceries, such as fruit and vegetables), when a retail item is stocked in low quantities (e.g., limited edition items, such as low-print run artwork or custom-made jewelry; or items in low stock, such as out-of-print books and music albums or popular toys during a holiday shopping season), or when the store is located in different city, state, or country. The systems and methods disclosed herein also allow live interaction between customer and retailer, which can aid in guiding a customer to the product for which they were searching and/or guiding a customer to additional items that the customer may want to buy as well.

At block 210 of method 200 a live video chat is initiated, according to some embodiments. At block 210 a request to initiate a video chat is sent by a first user device 110 (e.g., a customer device) to a second or more user devices 110 or a retailer device 120. As depicted in FIG. 1, the parts of system 100 may be directly or indirectly coupled to each other in electronic communication. For example, requests and data may be sent directly between devices 110 and 120, or via a back-end system 130, which can comprise one or more servers. Initiation of a video chat may include registering a new video chat on a real-time database. The real-time database may be part of or separate from a video chat module of the system. Upon registration in the real-time database, a connection is opened to send and receive video and sound data via the video server which may be part of the video chat module. A voice-over-internet-protocol (VOIP) request is sent to invited devices, such as retailer device 120 and customer device 110. The device that initiated the video chat waits for an answer from invited devices. For example, the customer device can initiate the video chat and can wait for an answer from at least one invited device (e.g., the retailer device and/or one or more additional customer devices). In some cases, the retailer device can initiate the video chat and can wait for an answer from at least one invited device (e.g., at least one customer device). Upon receiving an answer from the invited devices, each respective user device (e.g., customer device 110 and retailer device 120) registers a new video chat on the real-time database and then opens a connection to receive video and sound data from the video server of the video chat module. The invited devices (e.g., the second or more user devices or retailer devices) may confirm the request to initiate a video chat, after which a video chat between the users and their devices begins. In some cases, a video chat layer is established in the retailer device (e.g., via the retailer device display) before the video chat is initiated. In some cases, a video chat layer is established in the retailer device after the video chat is initiated. In some cases, a video chat layer is established in a customer device (e.g., via the display of the customer device) before the video chat is initiated. In some cases, a video chat layer is established in a customer device after the video chat is initiated. Additional embodiments of establishing a video chat among a plurality of devices is disclosed in U.S. Patent Publication No. US20180316964A1, which is incorporated herein by reference in its entirety.

During the video chat, the retailer may use the retailer device to transmit video to the customer. Transmitting video from the retailer device to the customer (e.g., via the customer device) allows a retailer to visually show the customer options of products available for purchase (e.g., based on information provided via the customer device, for example, through verbal communication during the live chat or through purchase history information received by back-end system 130 from customer device 110). Video chat also allows a retailer to physically manipulate a product to facilitate a customer's decision to purchase an item. For example, a customer may ask a retailer to rotate, demonstrate the use of, or show details of a product being shown to the customer by the retailer via the video chat. This represents a significant advantage over still two-dimensional images, rotatable images, GIF-format images, and even pre-recorded video that may be used in conjunction with a traditional, internet-based website, as such images and videos generally do not allow, for example, the manipulation of the product relative to a light source (e.g., to illustrate the colors of the product), the demonstration of a product's weight, or the demonstration of how a product's materials move and/or deform (which can be important, for example, in clothing retail), or the demonstration of how one or more products under consideration function (e.g., relative to a similar product).

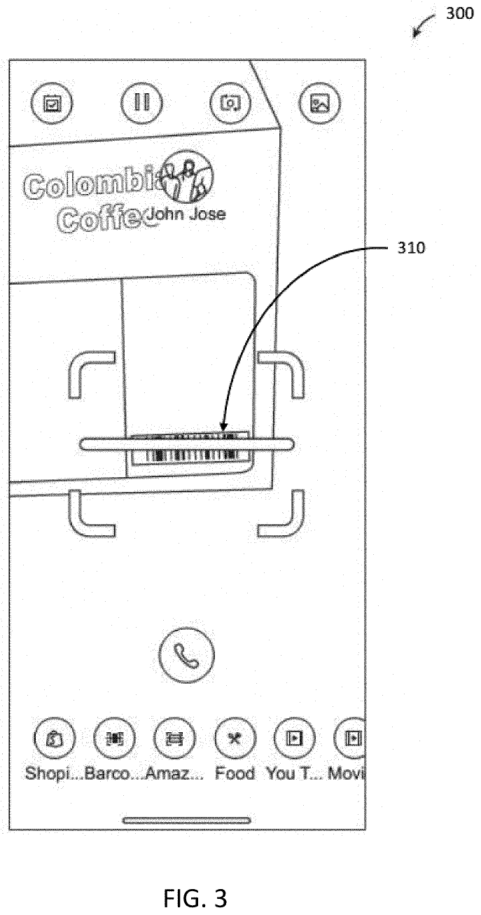

Simultaneously with the display of live video, at block 220, the retailer may scan or enter product identification information (e.g., a stock keeping unit (“SKU”) code, a universal product code, (a “UPC”), or a European article number (“EAN”)). FIG. 3 depicts the display 300 and scan of a UPC 310 of a product during a video chat. In some cases, an option to initiate a product identification information scan or product identification information entry is presented to the retailer within the video chat application (e.g., in the form of a button on the video chat user interface or as a product identification information layer overlay on the live video). For example, a retailer may initiate product identification information entry (e.g., via manual entry of an alphanumeric stock keeping unit (“SKU”) code identifier or other product information, such as a keyword) or product identification information scan (e.g., captured via optical scan of a barcode, such as a UPC, for example, using an optical scanner of a retailer device) by pressing a button on an overlay of the video chat interface. In some cases, initiation of product identification information entry or a product identification information scan comprises activating an optical scanner (e.g., a camera) of the retailer device, initiation of an optical scanning program, and/or initiation of a keyword or SKU search of a product inventory database (or initiation of a prompt to initiate such a search), for example, via backend system 130. The product identification information (e.g., comprising a SKU code, a UPC code, an EAN code, a keyword, and/or a barcode) may be sent to a database 150 (e.g., UPC database 150) through the backend system 130 to retrieve the product information which may then be used to access and/or retrieve product retail information, such as product availability, price, and/or description from a commerce platform 140. For example, a product identification information query (e.g., created from or populated by product identification information received from a scan or manual inputting of product identification information, for example, via a product identification information input layer) can be sent to a retail inventory database (e.g., located in commerce platform 140 or elsewhere in the system) via backend system 130.

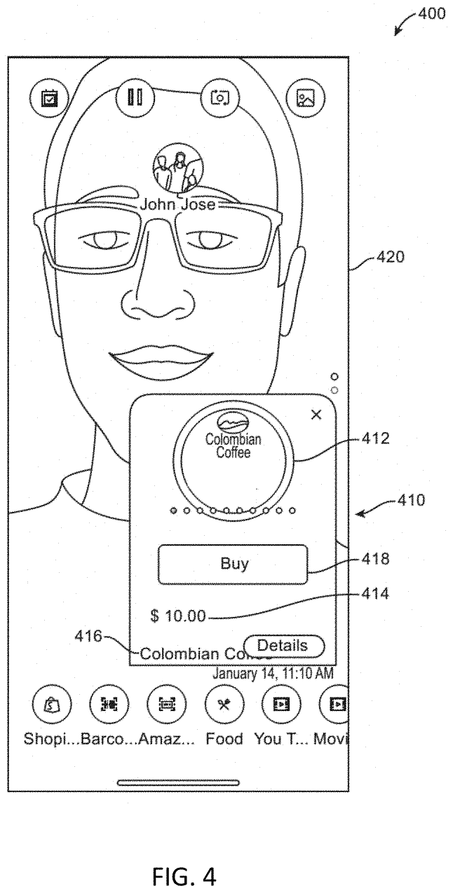

In some embodiments, the product identification information query (e.g., comprising product identification information acquired via scan or entry of a UPC code) may be used to directly retrieve product retail information from the commerce platform 140. For example, up-to-date product information can be retrieved (e.g., from commerce platform 140) and displayed on the retailer device 120, the customer device 110, or both devices (e.g., via back-end 130). At block 230, product information may be pushed or otherwise sent to the customer device 110. FIG. 4 depicts a display 400 of the product retail information 410 (e.g., product retail information retrieved from commerce platform 140 and/or an inventory database) over the top of a live video feed 420 on a customer device. The product information 410 may include a product image 412, product price 414, and product description 416. Additional, other product information may also be provided and displayed. For example, up-to-date product inventory data retrieved from an inventory database or commerce platform 140 can be provided and displayed (e.g., on the customer device via a customer input layer). The display 400 may also include a means for receiving a purchase request from a customer device, such as button 418. Additional embodiments of establishing and using data input and search layers in devices (e.g., a plurality of devices involved in multichannel live video chat) are disclosed in U.S. Patent Publication No. US20180316964A1, which is herein incorporated by reference in its entirety.

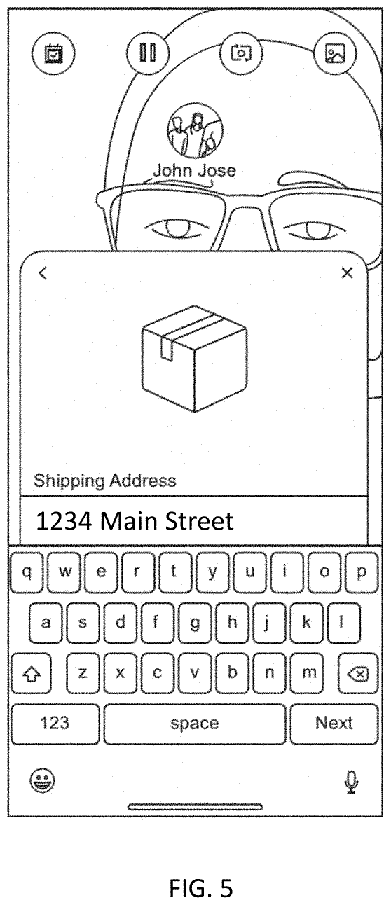

At block 240, after receiving a request to purchase a product, the sale of the product is completed. In many embodiments, the retailer completes the sale of the product, while the customer remains in the video chat interface and without the customer leaving the video chat to use a separate web browser to and website to complete the purchase. In some embodiments, a sales transaction is completed by sending purchase information received via a customer input layer displayed on the customer device to a commerce platform 140 (e.g., via back-end system 130). In some cases, completing a sales transaction (e.g., a sales transaction initiated via live video chat, as disclosed herein), for example via commerce platform 140, comprises processing a credit card payment, payment by e-check, or a wire transfer payment. In some cases, completing a sales transaction comprises verification of payment. FIG. 5 depicts the customer's entry of shipping/delivery information and other information as part of the purchase and sale process within the video chat via a customer input layer. In some embodiments, product identification information (or product retail information) associated with a plurality of products (e.g., a plurality of products having different stock keeping unit codes) may be retrieved and/or displayed simultaneously. In some embodiments, a retailer may scan multiple items (and, optionally, discuss them with the customer) before a product is purchased. In some cases, product retail information corresponding to a plurality of products can be pushed or otherwise transmitted from retailer device 120 to customer device 110. In some embodiments, customer purchase information, such as account information and payment and shipping details, may be retrieved from a customer database 160. In some cases, an inventory database and/or a commerce platform can be updated based on purchase information received from customer device 110 (e.g., via back-end system 130). In some cases, purchase information is sent to a delivery database (e.g., for the purpose of scheduling a delivery of at least one product represented in the purchase information). In some cases, information from a customer database 160 (e.g., search history data, purchase history data, personal preference settings, personal interest settings, and/or lists of specific products indicated by a customer to be of interest) is used to select products for presentation to the customer (e.g., via an overlay layer established on the display of the customer device) as suggested options for purchase. In some cases, an algorithm is used to select products for presentation to the customer as suggested options for purchase (e.g., via an overlay layer established on the display of the customer device). In some cases, information from customer database 160 and/or information from a list of promoted products (e.g., which can be defined or informed by preferences set prior to the establishment of the live video chat) is used by an algorithm to select products for presentation to the customer as suggested options for purchase. In some cases, one or more algorithms used to select products for presentation to the customer as suggested options for purchase comprises a machine learning algorithm. In some cases, the machine learning algorithm used to select products for presentation to the customer as suggested options for purchase is located in a server (e.g., a server accessed via the internet).

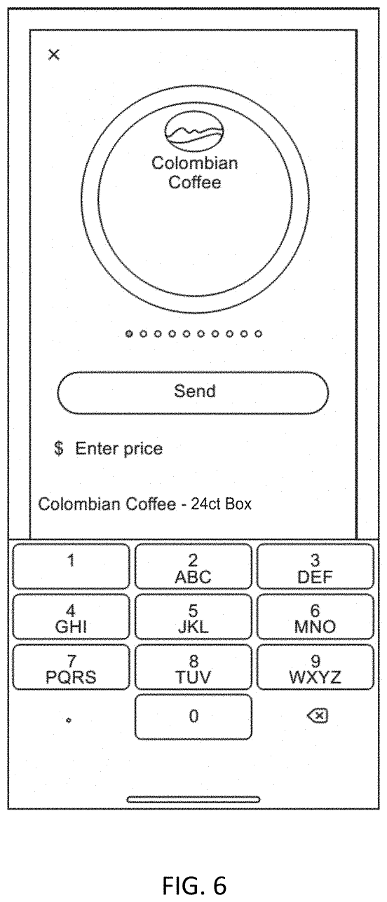

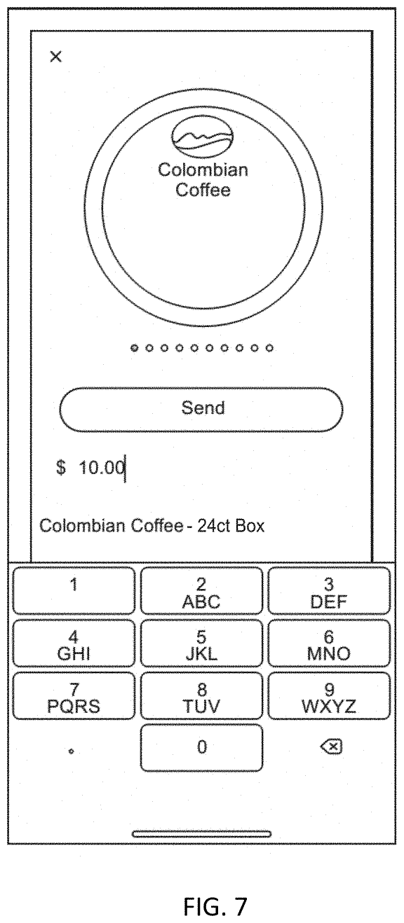

In some embodiments, the retailer may update the product information during the video chat. For example, FIGS. 6 and 7 show a prompt for and the entry of updated product information, respectively. In FIGS. 6 and 7 a product price is entered, but other product information, such as style, color, quantity, etc, may be modified. In some cases, a product price can be modified during a video chat (e.g., based on a discount applied directly by the retailer via retailer device 120, a discount applied by a customer via customer device 110 (e.g., by entering a discount code into a customer input layer), or based on time-based fees (e.g., service charges for time spent in video chat) and/or additional flat fees accrued during the video chat (e.g., the provision of consulting advice to the customer by the retailer or a retailer's associate). In some embodiments, the customer may modify such information, for example, to select the particular product amounts and styles for purchase.

During the video chat, the customer (e.g., via a customer input layer on customer device 110), the retailer (e.g., via a product identification information layer on retailer device 120), or both have the ability to access product identification information and/or up-to-date product inventory data (e.g., via back-end system 130), in some embodiments. In some cases, product identification information and/or product inventory data can be pushed or transmitted from a first device to a second device of the system (e.g., via back-end system 130).

In some embodiments, the video chat module includes one or more submodules for creating and/or editing delivery/shipping information within the video chat in real-time. In some cases, a submodule of the video chat module receives delivery/shipping information from a current user device participating in the video chat and transmits the data to a delivery device operated by a delivery driver or delivery dispatcher and/or to a delivery scheduling platform (e.g., via an API). In some cases, a method disclosed herein comprises scheduling a delivery (e.g., via a delivery scheduling platform) of a product (e.g., a product purchased during a live video chat). In some cases, scheduling delivery (e.g., shipping means or delivery dates) of a product purchased during live chat is automatically initiated after the product is purchased via the live video chat system. Additional embodiments of establishing and using modules and layers in devices for scheduling events (e.g., using data input via a device involved in multichannel live video chat), which can be used in methods and systems disclosed herein are disclosed in U.S. Patent Publication No. US20180316964A1, which is herein incorporated by reference in its entirety.

The connections among devices and modules of the systems disclosed herein (e.g., the systems illustrated in FIG. 1) may be physical electronic connections or may comprise communication paths between the various devices and servers. In many embodiments, the devices of systems 100 are connected to one another through the servers or directly. In some cases, a direct connection between two or more of the devices does not pass through a server of system 100 but may pass through other servers such as servers and routers on the Internet. Such servers and routers may not be associated with or otherwise under the control of the system 100. A first device such as customer device 110 may search and/or retrieve data through a server API of a search server.

In some cases, system 100 comprises a real-time database server, which can act, in part, as a router of information and data between customer device 110 and retailer device 120.

In some cases, a video server acts, in part, as a router of video and sound data, such as the video and sound associated with the video chat, between customer device 110 and retailer device 120.

In some cases, a VOIP notification server acts, in part, to coordinate the initiation and confirmation of VOIP information, between customer device 110 and retailer device 120. Additional embodiments of servers and APIs useful in establishing live video chat in which data is shared between a plurality of devices are disclosed in U.S. Patent Publication No. US20180316964A1, which is herein incorporated by reference in its entirety.

A customer device and/or a retailer device can send a query or request to the search server during a video chat. The customer device and/or retailer device displays input options, for example, via a product identification information input layer or a customer input layer on top of the video view layer. Such and overlaid layer can be a rectangle that partially covers the video view layer. An overlay layer (e.g., product identification information input layer or a customer input layer) does not fully cover the video view layer in some cases, as it is often advantageous to allow a user (e.g., a retailer or customer) to input data for sending while the video chat is still in session. A list of results or product information (e.g., product retail information) can be displayed on one or both of the customer device's display or the retailer device's display.

Discovery of content within live video chat allows a user to select product information in real-time and share with others. Users are able to filter content while in the video screen without having to navigate to different apps on the devices that they are using.

Data retrieved by back-end system 130 can be displayed on a video chat on a user device (e.g., customer device 110 and/or retailer device 120).

While participating in a video chat, multiple activities are conducted and displayed on a user device display simultaneously in layers. The activities may be related to the other member(s) of the video chat or the topic of the video chat, but do not have to be. In some cases, customers and retailers are able to use all of the functionality of the system while on a video chat and do so in a way that all or none of the actions that they take are visible to the other member(s) of the video chat. These actions include running a search of database(s) external to the system (e.g., accessed via the internet) for similar products in order to perform price comparisons. Additional embodiments and approaches for establishing layers in a live video chat between a plurality of devices are disclosed in U.S. Patent Publication No. US20180316964A1, which is herein incorporated by reference in its entirety.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on. Additional system components and configurations useful in establishing a live video chat in which data is passed between a plurality of devices are disclosed in U.S. Patent Publication No. US20180316964A1, which is herein incorporated by reference in its entirety.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of facilitating electronic commerce comprising:
sending, from a retailer device to a customer device, a request to join a video chat;
establishing, on the retailer device, a video layer;
establishing, on the retailer device, a product identification information input layer;
receiving, from the retailer device, a product identification information query comprising product identification information via the product identification information layer;
retrieving product retail information;
sending, for display on the customer device, the product retail information;
receiving, from the customer device, purchase information via a customer input layer.

2. The method of claim 1, wherein the product retail information is displayed via the customer input layer.

3. The method of claim 1, wherein the product retail information comprises a product image, a product price, a current product inventory, or a product description.

4. The method of claim 1, further comprising updating an inventory database based on the purchase information.

5. The method of claim 1, further comprising activating an optical scanner of the retailer device in response to user input received via the product identification information input layer.

6. The method of claim 5, further comprising receiving the product identification information via the optical scanner.

7. The method of claim 1, wherein the product identification information query comprises product identification information corresponding to a plurality of products having different stock keeping unit codes.

8. The method of claim 7, comprising retrieving product retail information associated with each product of the plurality of products.

9. The method of claim 1, further comprising processing a sales transaction based on the purchase information.

10. The method of claim 1, further comprising receiving delivery information via the customer input layer.

11. The method of claim 10, further comprising scheduling delivery of a product based on the delivery information.

12. The method of claim 1, further comprising establishing a video chat layer on the customer device.

13. A system for facilitating electronic commerce via a display of a retailer device, comprising:
the display;
a processor; and
a memory comprising a program code, that when executed by the processor causes the processor to:
receive, from a customer device, a request to join a video chat;
display, on the retailer device, a video chat layer;
display, on the retailer device, a product identification information input layer;
receive, from the retailer device, a product identification information query comprising product identification information;
retrieve product retail information based on the product identification information query;
send, to the customer device, the product identification information; and
receive, from the customer device, purchase information via a customer input layer.

14. The system of claim 13, further comprising an optical scanner configured to capture product identification information.

15. The system of claim 14, wherein the program, when executed, causes the processor to activate the optical scanner in response to a command entered via the product identification input layer.

16. The system of claim 14, wherein the program, when executed, causes the processor to populate the product identification information query with product identification information received from the optical scanner.

17. The system of claim 13, further comprising a server configured to communicate data between the retailer device and one or more system components selected from a commerce platform, an inventory database, or a customer database.

18. The system of claim 13, further comprising a server configured to communicate data between the customer device and one or more system components selected from a commerce platform, an inventory database, or a customer database.

19. The system of claim 13, wherein the program, when executed, causes the processor to communicate purchase information to a delivery database.

20. The system of claim 13, wherein the product identification information query comprises product identification information corresponding to a plurality of products.
